(19) United States
(12) Patent Application Publication
(10) Pub. No.: US 2013/0073350 A1
(43) Pub. Date: Mar. 21, 2013

(54) PARKING SPACE MANAGEMENT SYSTEM AND METHOD

(71) Applicant: Tomer Blustein, Ramat Hasharon (IL)

(72) Inventor: Tomer Blustein, Ramat Hasharon (IL)

(73) Assignee: PINK PARK LTD., Kfar Saba (IL)

(21) Appl. No.: 13/700,510

(22) PCT Filed: Apr. 11, 2011
(86) PCT No.: PCT/IL2011/000298

§ 371 Date: Nov. 28, 2012

Related U.S. Application Data
(60) Provisional application No. 61/350,058, filed on Jun. 1, 2010.

(30) Foreign Application Priority Data
Dec. 13, 2010 (IL) 209959

(51) Int. Cl. G07B 15/02

(52) U.S. Cl. 705/13

(57) ABSTRACT

The present invention relates to a system and method for allowing owners of private parking spots to rent their parking spots for occasional vehicles in real time, wherein the system is able to distinguish between occasional vehicles parked in the parking spot and vehicles belonging to the owner of the parking lot.

### FIELD OF THE INVENTION

The present invention relates to the field of parking space management system. More particularly, the invention relates to a method and system for allowing a driver of a vehicle to rent an available private parking space.

### BACKGROUND OF THE INVENTION

Parking a car in many cities is a frustrating adventure due to the scarcity of public parking and the high cost of garages. Although public parking (e.g. meters, residential parking, un-metered parking spots, and illegal parking spots) is inexpensive, it is inconvenient because the supply of parking spots is too low. Finding a parking spot typically requires time, luck, spare change, and/or the risk of an expensive parking ticket or towing. Parking garages may be more convenient in that available parking spots may be easier to find, but the cost of such a parking spot is significantly higher.

The ever-increasing use of automobiles and limited space for parking, particularly in urban areas, has led to serious problems in parking management. It is often expensive and logistically cumbersome for police or municipality officials to keep track of offenders who park their vehicles without paying for the parking space. Parking meters do not fully solve the problem because they require a large investment on the part of the municipality and comprehensive monitoring by enforcement personnel.

Another parking management problem is the ever-growing lack of parking space available. It is difficult, if not impossible, for a driver wishing to travel to an urban district to know ahead of time if there will be available parking space. In short, there is a lack of communication in the field of parking management, between municipality, driver and parking space.

Therefore, to address these problems and to provide a much convenient, better accessible and cost effective parking solution, there is a long felt need to develop a system and method which will be able to put into use a wider range of existing parking spots which till now were restricted, in particularly managing parking spaces which will provide ability to owners of private parking spaces to rent they're own parking spots to other vehicle drivers. Moreover, there is a long felt need to develop a system which will have improved means for informing drivers when an available parking space is located on their way. Furthermore, this system should take in advantage various limitations such as: a parking which has to be fitted for disabled people, a parking for not fuel-only vehicles, and other limitations as will be disclosed below.

It is an object of the present invention to provide a system which is capable of increasing the number of available parking spots using the existing available infrastructures or resources.

It is another object of the present invention to provide a system which is intended to comply with all the above requirements.

Other objects and advantages of the invention will become apparent as the description proceeds.

### SUMMARY OF THE INVENTION

The present invention relates to a system for allowing owners of private parking spots, to rent their parking spots for occasional vehicles in real time, wherein said system is able to distinguish between occasional vehicles parked in the parking spot and vehicle(s) belonging to the owner of said parking lot, said system comprises: a) a central computerized unit provided with dedicated software for remotely controlling and managing registered private parking spots located within each parking area, wherein said registered private parking spots are available for rent for said occasional vehicles, by the owners of said private parking spots, for a limited or predetermined period of time; b) sensing means for providing information in real-time regarding the availability of said parking spot, wherein said sensing means are located within said parking area or said parking spot; c) a communication unit for allowing said sensing means to communicate with said central computerized unit; d) a mobile device capable of communicating with said central unit for retrieving information regarding available parking spot(s) according to the range of one or more parameters provided by the driver of the occasional vehicle and/or by said mobile device; e) a display unit, configured to communicate with said mobile device, for displaying said retrieved information regarding available parking spot(s) according to said one or more parameters and, if exist, displaying other information (i.e., parking spot attributes) regarding parking an occasional vehicle in said available parking spot(s); f) an input means, configured to communicate with said mobile device or with said display unit, for allowing the driver of said occasional vehicle to select one of said available parking spots, thereby informing said central unit the intention of said driver to park an occasional vehicle in said selected available parking spot; and g) reporting means for reporting said central unit the parking starting time of said occasional vehicle in said selected parking spot, or alternatively, for reporting said central unit whenever said parking spot is occupied by a vehicle related to the owner of said parking spot.

According to an embodiment of the present invention, the mobile device further comprises a GPS module. Preferably, but not limitatively, the display unit and the input means are integral part of the mobile device. For example, the mobile device can be selected from the group consisting of cellular phone, smart phone, PDA, netbook, laptop, and the like.

Optionally, a Radio Frequency tag (RF tag) can be associated with the central computerized unit and with the occasional vehicle or the mobile device, thereby allowing the driver of the occasional vehicle to be identified by a corresponding RFID reader located within the private parking spot, wherein said RFID reader can be operated as the reporting means.

According to an embodiment of the present invention, the one or more parameters are provide by the driver of the occasional vehicle or by the mobile device, and which said parameters are selected from the group consisting of: a destination address, the current location of the occasional vehicle or the mobile device, departure time, vehicle identification information, parameters related to the surrounding or infrastructure of a parking spot, or any combination thereof.

According to an embodiment of the present invention, the other information is provided by the central unit, and which said other information is selected from the group consisting of: the distance of the available parking spot(s) from the vehicle or the mobile device, the distance of the available parking spot(s) from the destination address, parking rate(s) of each available parking spot, parking spot's address or other guiding information (e.g., may also include a visual image of the parking spot), the departure time or any other restricting information regarding the parking of a vehicle in said parking spot(s), a unique identification code for each parking spot, or any combination thereof.

According to an embodiment of the present invention, the system further comprises a billing module for charging the owner of the vehicle or the mobile device according to the parking period of said vehicle in the available parking spot.

According to an embodiment of the present invention, the system further comprises marking means, located within the parking area or the parking spot, for aiding the driver of the vehicle to identify or distinguish the selected available parking spot. The marking means are selected from the group consisting of: a unique identification character(s), a specific logo, a sign, at least partially painted zone on the surface of the parking spot, or any combination thereof.

According to an embodiment of the present invention, the reporting means are either passive or active means. For example, the reporting means are actively operated by the input means, and they can be passively operated whenever the current location of the mobile device and the coordinates of the selected parking spot are within the same predetermined range. The reporting means can be located within the parking area or the parking spot, wherein said reporting means are selected from the group consisting of: a remote control, keypad, touch screen, mechanical operated mechanism (e.g., operated by key, by lever, by handle, etc.), biometric reader, optical module for identifying the parking vehicle or its license plate, RFID reader, or any combination thereof.

According to an embodiment of the present invention, the system further comprises a physical barrier located at the entrance to the parking area or the parking spot, wherein said barrier is being operated by said reporting means either locally by the driver of the vehicle or remotely by the central unit.

According to an embodiment of the present invention, the system further comprises an external display means located nearby the parking area or parking spot for indicating the availability state of said parking spot and/or for displaying other information related to said parking spot.

The present invention further relates to a method for allowing owners of private parking spots, to rent their parking spots for occasional vehicles in real time, while enabling to distinguish between occasional vehicles parking in the parking spot and vehicle(s) related to the owner of said parking lot, which comprises the steps of: a) providing a central computerized unit for remotely controlling and managing registered private parking spots located within each parking area, wherein said registered private parking spots are available for rent for said occasional vehicles, by the owners of said private parking spots, for a limited or predetermined period of time; b) registering one or more private parking spot to said central computerized unit via a browser or by using any suitable terminal equipment; c) providing information in real-time regarding the availability of said registered parking spot to said central unit by using sensing means which are configured to communicate with said central unit, wherein said sensing means are located within said parking area or said parking spot; d) providing a mobile device capable of communicating with said central unit for retrieving information regarding available registered parking spot(s) and according to the range of one or more parameters; e) displaying said retrieved information regarding available parking spot(s) and according to said one or more parameters and, if exist, displaying other information regarding parking of an occasional vehicle in said retrieved available parking spot(s); f) selecting one of said displayed available parking spots by the driver of said occasional vehicle; g) informing said central unit the intention of said driver to park an occasional vehicle in said selected available parking spot; and h) reporting said central unit, by using reporting means, the parking starting time of said occasional vehicle in said selected parking spot, or alternatively, reporting said central unit whenever said parking spot is occupied by a vehicle related to the owner of said parking spot.

### BRIEF DESCRIPTION OF THE DRAWINGS

In the drawings:

FIG. 1 is schematically illustrates a parking system, according to an embodiment of the present invention;

FIG. 2 is schematically illustrates the parking system provided with an access control unit, according to an embodiment of the present invention; and

FIG. 3 is schematically illustrates the parking system provided external displaying means, according to an embodiment of the present invention.

### DETAILED DESCRIPTION OF PREFERRED EMBODIMENTS

### Definitions

The terms “parking space” or “parking spot” refer herein to a location in which at least one vehicle is able to park for a predetermined period of time.

The term “parking area” refers herein to a location which comprises at least one parking space. A parking space may be, for example: a garage, a building, a living house, a public facility, a municipal area, a street.

The term “subscriber” refers herein to any person which may be interested in the service of the system of the present invention.

The term “not fuel-only vehicles” refers herein to vehicles which are motorized via means which are not necessarily based on fuel. For example: hybrid vehicles, electric vehicles, gas vehicles, etc.

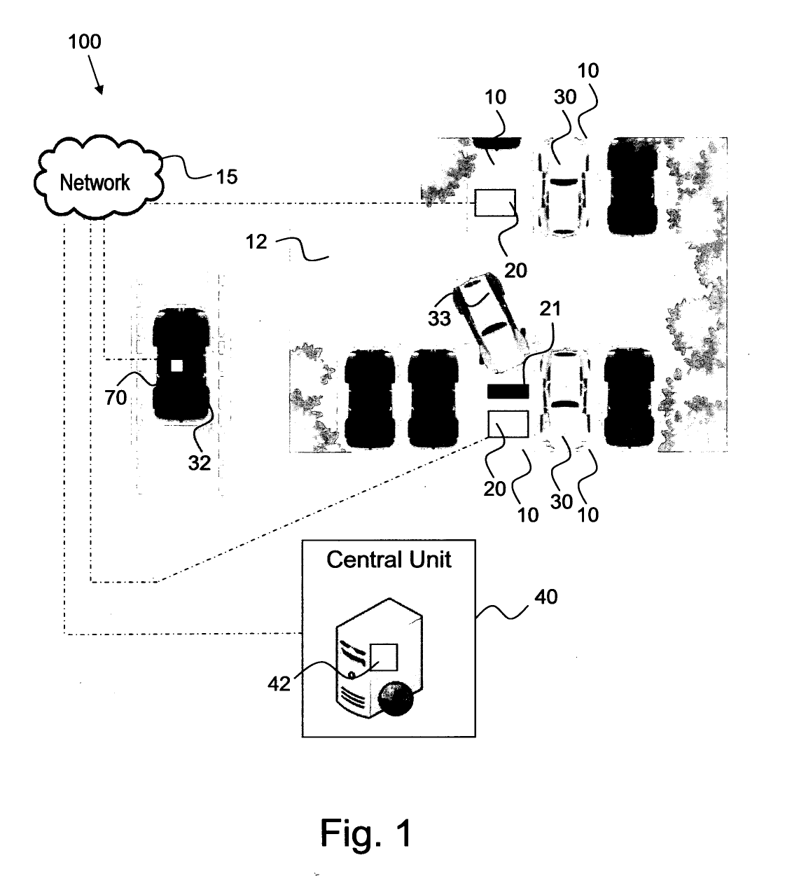

Reference is now made to FIG. 1, which schematically illustrates a specific embodiment of a parking system, according to an embodiment of the present invention. Parking system 100 is used for managing parking spaces (e.g., as those indicated by numeral 10) within parking area 12 through an electronic communication network 15.

System 100 is adapted to provide an ability of at least part of subscribers (e.g., an owner of at least one parking space 10) to register their private parking spaces 10 to system 100, and thereby to offer their private parking spots for rent to other subscribers (e.g., drivers of occasional vehicles, such as vehicles 30, 32 and 33), preferably, for a limited period of time. For example, when an owner is not at home at predetermined period of the day, he can offer other subscribers of the system 100 to use his parking space 10 during this period of the day. According to some embodiment, a subscriber may own at least one parking space which is rentable to other subscribers. According to some embodiments, subscribers of the system 100 may own at least one vehicle which is adapted to be parked in at least one of the registered parking spaces 10. According to some embodiments, a parking area may comprise only a parking space, so that in such cases a parking area and a parking space may have the same meaning.

Subscribers of system 100 can be either registered user or temporary users (which are usually occasional drivers who use the service offered by system 100 by chance). The subscription to system 100 can be done by users in various ways, such as via a telephone call to a calling center, via a website, or by any other common registering means as are known to a person skilled in the art.

According to the specific embodiment of FIG. 1, system 100 comprises the following main components: sensing means, such as transceivers 20, communication network 15 and a central computerized unit 40. Central unit 40 is in communication with transceivers 20 via network 15. Each transceiver 20 is adapted to detect presence or absence of a vehicle parking in a parking space 10 for defining an available or an occupied status for each registered parking space. According to some embodiments, transceivers 20 are adapted to detect presence or absence of vehicles in the parking spaces 10 via a sensing subsystem 21 selected from the group consisting from: IR sensors, mechanical sensors, video sensors, presence sensors, optical sensors, temperature sensors, magnetic field sensors, electrical field sensors, sound sensors, pressure sensors, light sensors, any other types of sensors, or any combination thereof.

According to an embodiment of the invention, system 100 further comprises reporting means for reporting the central unit 40 the parking starting time of the occasional vehicle in the specific parking space 10, or alternatively, for reporting the central unit 40 whenever the parking space is occupied by a vehicle related to the owner of the registered parking space. According to other embodiment of the invention, the sensing means 21 can also be used as the reporting means. The reporting means can be located within the parking area or at the parking apace. The reporting means are selected from the group consisting of: a remote control, keypad, touch screen, mechanical operated mechanism (e.g., operated by key, by lever, by handle, etc.), biometric reader, optical module for identifying the parking vehicle or its license plate, RFID reader, etc., or any combination thereof.

Each of the elements of system 100 which is located in the parking area (i.e., the sensing means, the reporting means, and other additional elements as described herein after, such as the access control unit 50) can be energized by any one or more suitable or available energy sources, such as a solar panel (i.e., photoelectric cell), electricity network, etc.

According to an embodiment of the present invention, the sensing means 21 and/or the reporting means are used to report central unit 40 (e.g., via transceiver 20) whenever a parking vehicle has left or exit the parking spot. Accordingly, this can be used to automatically stop the parking charging fee for that vehicle. Optionally, system 100 can be configured to send an alert message or other type of data (such data may also include a currently taken photographed image of the parking spot e.g., by an imaging device located in the parking area or parking spot) regarding the current status of the parking spot. Such a message can be sent to the owner of the subscribed parking spot (e.g., as a status report of the parking spot whether it occupied or not) and/or to another subscriber which is related to parking vehicle (e.g., inform such a subscriber whenever the vehicle has left the parking spot, or to send him an updated digital photo of the vehicle). For example, the message can be sent in form of a SMS or MMS messages to a mobile device of the relevant subscriber.

According to some embodiment of the invention, such an alert message configuration can be used as an alert mechanism in case of a theft attempt. For example, in such case an imaging device can be used also as a sensor of a motion detection unit, thus central unit 40 will send a message to the vehicle driver (or other subscriber) in case a suspicious activity occurs nearby the vehicle.

According to an embodiment of the present invention, system 100 further configured to communicate with a subscriber mobile device 70 in order to allow a driver of a vehicle (either a subscribed user or a non-subscribed user) to find an available parking spot. Subscriber mobile unit 70 can be any suitable mobile device, such as a simple cellular phone, a smart phone, iPhone, PDA, netbook, laptop, or other device or dedicated device provided with wireless communication capabilities. Preferably, the mobile device 70 need to be in communication with a corresponding display unit and input means (which usually they are integral part of such mobile device).

According to an embodiment of the present invention, the mobile device 70 may further comprise a GPS module. According to some embodiment of the present invention, a dedicated software application can be installed within suitable mobile devices (e.g., iPhone app) in order to provide the subscriber (e.g., the driver of a vehicle 32) a much user friendly way to interact with central unit 40. The interaction between central unit 40 and the mobile device 70 can be done via the corresponding display unit, the input means, a speaker (or earphone) related to the mobile device 70 or any combinations thereof.

Central unit 40 (e.g., a network server) comprises a database 42 which is adapted to store all the information which is relevant for the management of the system and the registered parking spaces. As part of the management process of system 100, central unit 40 is adapted to perform at least the following operations:
(i) storing in database 42 the following information:
   a. parking space attributes for each of parking spaces 10; and,
b. attributes of subscribers (i.e., one or more parameters that are provide by the driver of the occasional vehicle and/or by a mobile device related to that driver or occasional vehicle);
(ii) communicating with the subscribers of system 100;
(iii) communicating with transceivers 20;
(iv) updating the parking space attributes according to the status of each parking space 10, as received from transceivers 20; and
(v) registering users (i.e., parking space owners, drivers and vehicles). This can be done via dedicated website related to the central unit 40, telephone service center (either automatic or human operated).

According to some embodiments, the attributes of the subscribers further comprise the attributes of their vehicles (e.g., plate number, vehicle model, color, etc.), the parking space attributes may be selected from the group consisting of: geographical location of the parking space, to which parking area the parking space belongs, the size of the parking space, availability hours, prices, difficulty to park a vehicle in a specific parking space, availability of charging points adapted to charge electric vehicles, or any combination thereof, and the attributes of the subscribers may be selected from the group consisting of: ID, address, e-mail, password, vehicle details, credit card details, attributes of the vehicles they own. According to some embodiments, the availability hours may be determinable by the subscribers which own parking spaces 10. An owner of a parking space 10 may determine in which hours and days his parking space is available, and the system may detect and/or verify when the subscriber leaves his parking space. The availability hours may also be constant for a predetermined period of time.

According to an embodiment of the present invention, the one or more parameters which are provided by the driver of the occasional vehicle and/or by the mobile device, can be a destination address (e.g., either by providing the name of a business or a company, or by providing the physical address), the current location of the occasional vehicle or the mobile device, departure time, vehicle identification information, parameters related to the surrounding or infrastructure of a parking spot, etc., or any combination thereof.

According to an embodiment of the present invention, the parking space attributes are provided by the central unit 40, and it may include: the distance of the available parking spot(s) from the vehicle or the mobile device, the distance of the available parking spot(s) from the destination address, parking rate(s) of each available parking spot, parking spot's address or other guiding information such as a map (e.g., may also include an image showing a visual view of the parking spot for allowing a better identification of the parking space by the vehicle's driver), the departure time or any other restricting information regarding the parking of a vehicle in said parking spot(s), the option to send an alert or reminder message (e.g., SMS or voice message) prior to the parking end time period (i.e., departure time), a unique identification code for each parking spot, etc., or any combination thereof.

The subscribers of the system may also have an option to log into the central unit 40 (e.g., via an Internet browser) in order to request for availability of a parking space and/or offer for rent a private parking space. This may be performed via a user name and a password. The subscribers of the system may also have an option to pay for the service of system 100 by communicating with central unit 40.

According to an embodiment of the present invention, in case of parking violations (e.g., not allowed vehicle, unregistered vehicle, parking time exceed the departure time, etc.) the sensing means and/or the reporting means of system 100 can be used to report central unit 40 regarding such parking violations. Accordingly, central unit 40 may further report these parking violations to enforcement authorities (e.g., either public authority or private authority).

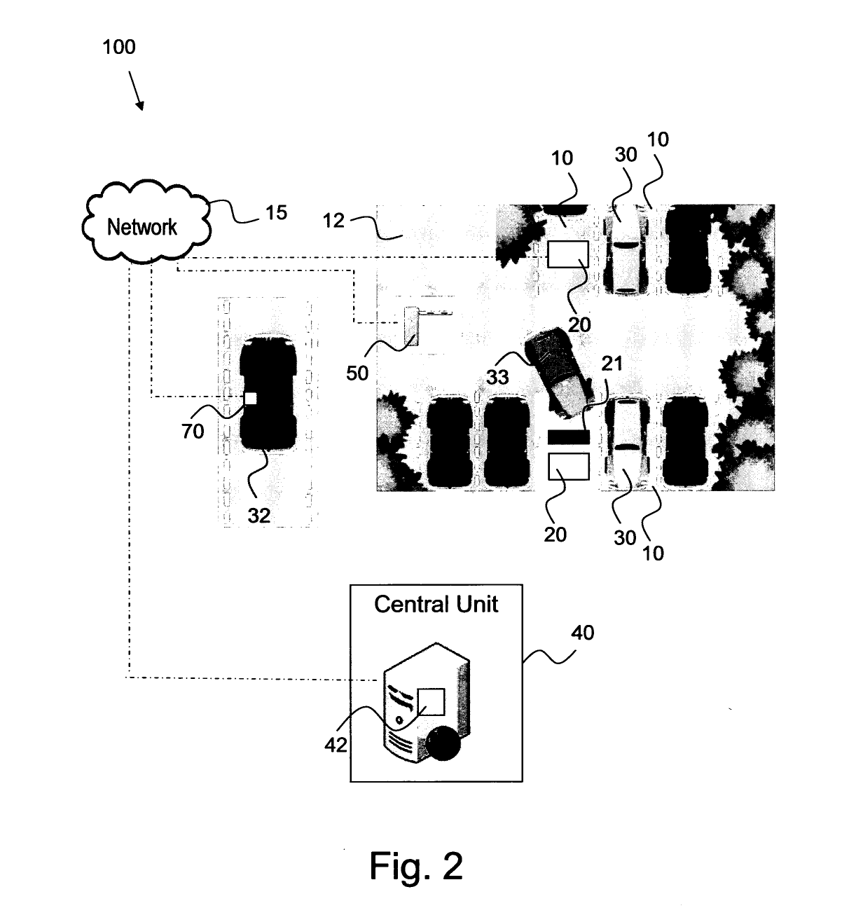

Referring now to FIG. 2, according to some embodiments of the present invention, system 100 may further comprises an access control unit 50, such as an electrically controlled physical barrier. Access control unit 50 may comprise a license plate detection system adapted to recognize a vehicle via an optical means, such as a camera or other imagining module (not show), and upon that to be activated. According to other embodiments, access control unit 50 may be activated by a reader suitable to electronically read a club card or a RFID tag. According to other embodiments of the present invention, access control unit 50 may comprise at least one sensing means selected from the group consisting from: RFID reader, IR sensors, mechanical sensors, video sensors, presence sensors, optical sensors, temperature sensors, magnetic field sensors, electrical field sensors, sound sensors, pressure sensors, light sensors, any other types of sensors, or any combination thereof. According to some embodiments, access control unit 50 is human-activated.

Access control unit 50 is adapted to manage the access of vehicle 32 to parking area 12. According to a specific embodiment of the present invention, as part of the management process, access control unit 50 is an electrical gateway which is adapted to allow vehicle 32 to enter to parking area 12. According to other embodiment, access control unit 50 is an electronic device which informs the driver if he is allowed to enter to parking area 12. As part of its operation, access control unit 50 is adapted to perform the following operations: (i) confirm according to said database the entrance and exit of vehicle 32 to and from parking area 12; (ii) control the operation of a gateway of parking area 12; (iii) register the parking durability of vehicle 32; and, (iv) manage the financial operations of system 100.

According to some embodiments, access control unit 50 comprises two gates (not shown) located in a distance which is at least a distance of a vehicle between each other. The two gates are adapted to improve the ability to provide entrance only to authorized vehicles.

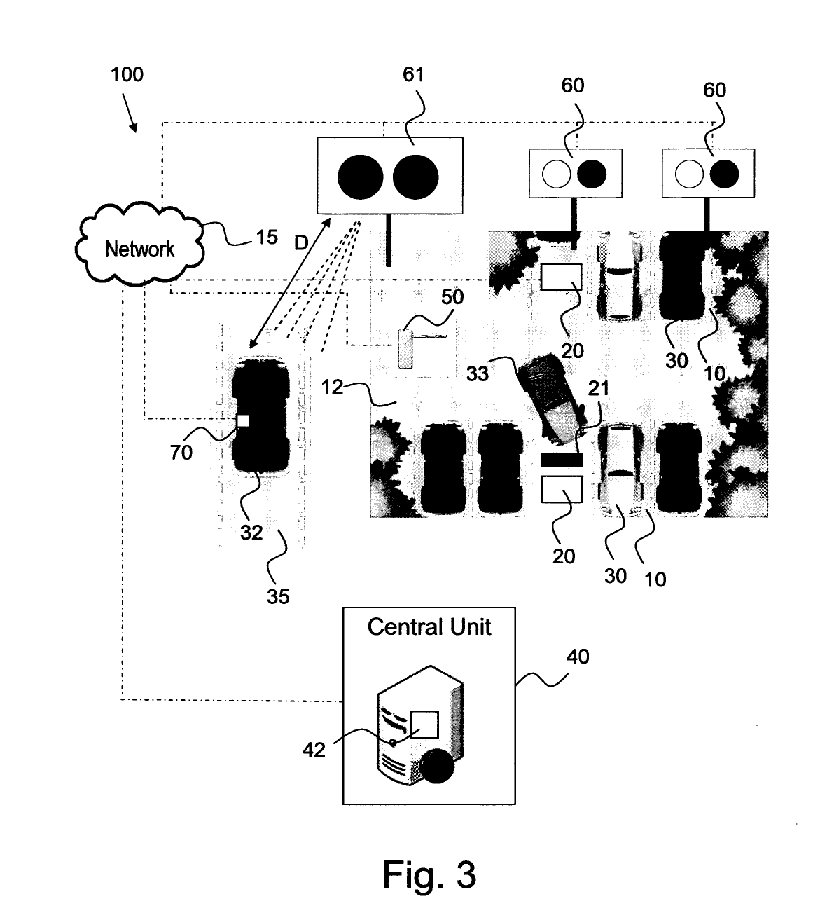

Referring now to FIG. 3, according to some embodiments, parking area 12 further comprises one or more traffic signs, and instructing signs, such as signs 60 and 61. It should be emphasized that the term sign in the present invention relates to a signboard, a digital sign, an electronic signs, LED signs, a display panel (e.g., LCD), or any combination thereof.

According to some embodiments, parking space 10 comprises a timer adapted to inform the subscribers or other occasional people (e.g., via sign 60) for how long the parking space is occupied (or, alternatively, free to use for parking). This may allow subscribers, as well as unregistered entities (e.g., people or vehicles), to park their vehicle in the available parking space instantly. In such cases, unregistered entities may require to contact the central unit 40 (e.g., by phone call) in order to illegally arrange the parking in that parking space.

According to another embodiment of the present invention, the sign is in fact a signaling system in which the color, pattern, intensity indicate the user as for the amount of time the parking space is free.

According to some embodiments of the present invention, central unit 40 may further communicates with external or traditional parking areas for providing the users of system 100 an alternative parking solution in case there are not available registered parking spaces.

According to some embodiments of the present invention, system 100 comprises an external display unit, such as a light-emitting signaling unit 61. Light-emitting signaling unit 61 is in communication with central unit 40 and is adapted to emit light for passively informing as for the availability of at least one of parking spaces 10 in parking area 12. Light-emitting signaling unit 61 is associated with each parking space 10. According to other embodiments, light-emitting signaling unit 61 is associated with parking area 12. Light-emitting signaling unit 61 is adapted to indicate availability parameters to at least one of said subscribers. For example, when subscriber which is driving vehicle 32 on road 35 is looking for an available parking space, he is able to see light-emitting signaling unit 61 from a predetermined distance D when driving at a predetermined speed.

The advantage of using light-emitting signaling unit 61 to deliver a specific message to a subscriber (e.g., a driver of an occasional vehicle) is in its simplicity. According to some embodiments, the light-emitting signaling unit 61 of the present invention is not only visible from a distance which is substantially the same distance in which parking area 12 is perceived, but also at any predetermined speed of driving which is available by vehicle 32. According to other embodiments, the light-emitting signaling unit 61 of the present invention is visible from a distance in which parking area 12 is not perceived. The light-emitting signaling unit 61 of the present invention exploits the same advantages as a traffic light has over any other means which are adapted to inform a driver about the traffic at an intersection (e.g., signs). According to some embodiments, said predetermined distance is between about 0.1 meter to about 1 km, and said predetermined speed of driving is between about 1 km/h to about 150 km/h.

According to some embodiments, light-emitting signaling units 60 and 61 comprise at least one light-emitting source which is adapted to indicate availability of parking space 10 in parking area 20. This indication is obtained by means selected from the group consisting of: intensity, color, graphical patterns, or any combination thereof. According to some embodiments, light-emitting signaling units 60 and 61 further comprise components selected from the group consisting of: a screen, a voice indicator, an internet system, a local information system, graphical symbols, letters, numbers, or any combination thereof. According to some embodiments of the present invention, the availability parameters are selected from the group consisting of: temporal availability, the number of available parking spaces in a parking area, the expected time in which a parking space will be available, or any combination thereof.

For example, light-emitting signaling units 60 and 61 are adapted to deliver a message (to parking space seekers) by various lightening means which are characterized by a predetermined pattern of illumination.

An example to the operation of light-emitting signaling unit 60: one blink of a green colored light-emitting source means an availability of a parking space for at least half an hour. Three short blinks of the green colored light-emitting source, mean an availability of a parking space for at least one hour and a half, and a maximum one hour and fifty nine minutes. If the parking space is available for at least ten minutes, and maximum 30 minutes, one blink of a red colored light-emitting source will be provided. If the parking space is not available for the next ten minutes, a continuous illumination of a red colored light-emitting source will be provided. Another example to the operation of light-emitting signaling unit 60 is when there is a correlation between the number of the activated green colored light-emitting sources, and the time in which the parking space is available. For example, three green lights mean an hour an a half of available parking space.

According to some embodiments, when light-emitting signaling unit 60 comprises a plurality of light emitting sources, the operation of each of them may be controlled by a controller in an individual manner. According to some embodiments, light-emitting signaling unit 60 is adapted to provide signaling which is selected from the group consisting of: a constant signaling; and, a time modulated signaling, to create predetermined graphical patterns, or any combination thereof.

Another novel feature of the present invention, is the ability of the access control unit 50 to confirm the entrance of vehicle 32 to parking area 12 according to the following attributes selected from a group consisting of suitability of the parking area for disabled drivers, permission for entrance of vehicles which are not fuel-only vehicles, information regarding roofed parking spaces, availability of charging points adapted to charge electric vehicles. These attributes are stored in the database of central unit 40, within the following attributes: (i) attributes of the subscribers; and, (ii) parking space attributes.

According to an embodiment of the present invention, subscriber mobile device 70 is in communication with central unit 40 and access control unit 50. Subscriber mobile device 70 is adapted to communicate between the subscribers of the system 100 and parking spaces 10 in a computerized manner. According to some embodiments, subscriber mobile device 70 is further adapted to control the operation of access control unit 50. This control may provide the ability to open the gateway of parking area 12, by mechanical or electronic means (e.g., a remote control). As aforementioned hereinbefore, subscriber mobile device 70 may be selected from the group consisting of a cellular phone, a computer, a notebook, a laptop, a smart phone, a telephone, an agent, a radio, RFID tag or any combination thereof.

Subscriber mobile device 70 is connectable with said at least one central unit through any suitable communication protocol (e.g., through an internet portal).

A subscriber may connect to system 100 by connecting to central unit 40. Following the connection, the subscriber may receive a list of available parking space in a predetermined geographical area. This list may be presented in an internet site, or may be associated with a map of the geographical area.

According to other embodiments, access control unit 50 is controllable manually. The manual control may be implemented when access control unit 50 is at least partially malfunctioning. In this case, access control unit 50 may be opened by a predetermined password which is supplied the system by a subscriber.

According to some embodiments of the present invention, central unit 40 is further adapted to receive reservation requests for parking spaces 10 from the subscribers of the system. According to other embodiments, central unit 40 is further adapted to update its database when new parking spaces are added to the system. For example, this can be performed when an owner of a parking space, decides that he wants to offer his parking space to other subscribers.

According to some embodiments, central unit 40 is further adapted to provide information to a subscriber regarding the availability of empty parking spaces in a predetermined geographical area, via subscriber mobile device 70. Moreover, central unit 40 may provide guiding information thereby guiding the subscriber to a specific parking space and/or parking area, so that he will locate the available parking space and optimally find said empty parking spaces. The guiding may be performed via instruction means (e.g., GPS, human instructor, cellular pointing, lightening instruction means, automatic voice guiding) which are adapted to guide said subscribers to locate a specific parking space in a specific parking area.

According to some embodiments, the instruction means is adapted to guide said subscribers to a specific parking space according to the suitability between the planned parking time by said subscriber and the available parking time of said parking spaces. For example, if the subscriber is looking for a parking space for two hours, and there are two available parking spaces: a first one for two and a half hour, and a second one for three hours, the system will guide the subscriber to the first parking space.

According to some embodiments, the information provide by light-emitting signaling unit 60 and/or 61 is incorporated within subscriber mobile device 70.

According to some embodiment of the present invention, system 100 further comprises an advertising server (not shown) for providing commercial content based on the current location of the vehicle's driver or based on the location of the desired parking area by the driver.

According to different embodiments of the present invention, the subscribers of the system are selected from the group consisting of: owners of said parking spaces, drivers of vehicles which are using said system for parking their vehicles, official authorities, the passengers of the vehicle, or any combination thereof.

According to different embodiments of the present invention, electronic communication network 15 is selected from a group consisting of: telephone, cellular network, wired/wireless communication, radio, internet, Bluetooth, GPS, wired internet, wireless internet, Wi-Fi, any other known in the art communication system, or any combination thereof.

According to other embodiments of the present invention, the system of the present invention is provided without plurality of transceivers 20. According to these embodiments, the system will be updated when a parking space is available/occupied by manual means, or other controlling means (without sensors).

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. A system for allowing owners of private parking spots, to rent their parking spots for occasional vehicles in real time, wherein said system is configured to send an alert message regarding the current status of the parking spot and the vehicle parking therein, said system comprising:
(a) a central computerized unit provided with dedicated software for remotely controlling and managing registered private parking spots located within each parking area, wherein said registered private parking spots are available for rent for said occasional vehicles, by the owners of said private parking spots, for a limited or predetermined period of time, and for sending the alert messages;
(b) sensing means for providing information in real-time regarding the availability of said parking spot and information related to the vehicle parked therein including information of suspicious activity nearby said parked vehicle, wherein said sensing means are located within said parking area or said parking spot;
(c) a communication unit for allowing said sensor to communicate with said central computerized unit;
(d) a mobile device capable of communicating with said central unit for receiving said alert messages and for retrieving information regarding available parking spot(s) according to the range of one or more parameters provided by the driver of the occasional vehicle and/or by said mobile device;
(e) a display unit, configured to communicate with said mobile device, for displaying said retrieved information regarding available parking spot(s) according to said one or more parameters and, if exist, displaying other information regarding parking an occasional vehicle in said available parking spot(s) or said alert messages;
(f) an input means, configured to communicate with said mobile device or with said display unit, for allowing the driver of said occasional vehicle to select one of said available parking spots, thereby informing said central unit the intention of said driver to park an occasional vehicle in said selected available parking spot; and
(g) reporting means for reporting said central unit the parking starting time of said occasional vehicle in said selected parking spot, or alternatively, for reporting said central unit whenever said parking spot is occupied by a vehicle related to the owner of said parking spot.

2. The system according to claim 1, in which at least one of the sensing means is an imaging device thereby allowing said system to be used as an alert mechanism in case of a theft attempt or to send an alert message that include an updated digital photo of the parked vehicle.

3. The system according to claim 1, further comprises an advertising server for providing commercial content based on the current location of the vehicle's driver or based on the location of the selected parking area.

4. The system according to claim 1, in which the mobile device further comprising a GPS module.

5. The system according to claim 1, further comprising a RF tag associated with the central computerized unit and with the occasional vehicle or the mobile device, thereby allowing the driver of the occasional vehicle to be identified by a corresponding RFID reader located within the private parking spot, wherein said RFID reader can be operated as the reporting means.

6. The system according to claim 1, in which the one or more parameters are provide by the driver of the occasional vehicle or by the mobile device, and which said parameters are selected from the group consisting of: a destination address, the current location of the occasional vehicle or the mobile device, departure time, vehicle identification information, parameters related to the surrounding or infrastructure of a parking spot, or any combination thereof.

7. The system according to claim 6, in which the other information is provided by the central unit, and which said other information is selected from the group consisting of: the distance of the available parking spot(s) from the vehicle or the mobile device, the distance of the available parking spot(s) from the destination address, parking rate(s) of each available parking spot, parking spot's address or other guiding information, departure time or any other restricting information regarding the parking of a vehicle in said parking spot(s), a unique identification code for each parking spot, or any combination thereof.

8. The system according to claim 1, further comprising a billing module for charging the owner of the vehicle or the mobile device according to the parking period of said vehicle in the available parking spot.

9. The system according to claim 1, further comprising marking means, located within the parking area or the parking spot, for aiding the driver of the vehicle to identify or distinguish the selected available parking spot.

10. The system according to claim 9, in which the marking means are selected from the group consisting of: a unique identification character(s), a specific logo, a sign, at least partially painted zone on the surface of the parking spot, or any combination thereof.

11. The system according to claim 1, in which the display unit and the input means are integral part of the mobile device.

12. The system according to claim 11, in which the mobile device is selected from the group consisting of: cellular phone, smart phone, PDA, netbook, or laptop.

13. The system according to claim 1, in which the reporting means are either passive or active means.

14. The system according to claim 13, in which the reporting means are actively operated by the input means.

15. The system according to claim 13, in which the reporting means are passively operated whenever the current location of the mobile device and the coordinates of the selected parking spot are within the same predetermined range.

16. The system according to claim 13, in which the reporting means located within the parking area or the parking spot, wherein said reporting means are selected from the group consisting of: a remote control, keypad, touch screen, mechanical operated mechanism (e.g., operated by key, by lever, by handle, etc.), biometric reader, optical module for identifying the parking vehicle or its license plate, RFID reader, or any combination thereof.

17. The system according to claim 13, further comprising a physical barrier located at the entrance to the parking area or the parking spot, wherein said barrier is being operated by said reporting means either locally by the driver of the vehicle or remotely by the central unit.

18. The system according to claim 1, further comprising an external display means located nearby the parking area or parking spot for indicating the availability state of said parking spot and/or for displaying other information related to said parking spot.

19. A method for allowing owners of private parking spots, to rent their parking spots for occasional vehicles in real time, while enabling to send an alert message regarding the current status of the parking spot and the vehicle parking therein, said method comprising the steps of:
(a) providing a central computerized unit for remotely controlling and managing registered private parking spots located within each parking area, wherein said registered private parking spots are available for rent for said occasional vehicles, by the owners of said private parking spots, for a limited or predetermined period of time, and for sending the alert messages;
(b) registering one or more private parking spot to said central computerized unit via a browser or by using any suitable terminal equipment;
(c) providing information in real-time, regarding the availability of said registered parking spot and information related to the vehicle parked therein including information of suspicious activity nearby said parked vehicle, to said central unit by using sensing means which are configured to communicate with said central unit, wherein said sensing means are located within said parking area or said parking spot;
(d) providing a mobile device capable of communicating with said central unit for receiving said alert messages and for retrieving information regarding available registered parking spot(s) and according to the range of one or more parameters;
(e) displaying said retrieved information regarding available parking spot(s) and according to said one or more parameters and, if exist, displaying other information regarding parking of an occasional vehicle in said retrieved available parking spot(s) or said alert messages;
(f) upon selecting one of said displayed available parking spots by the driver of said occasional vehicle informing said central unit the intention of said driver to park an occasional vehicle in said selected available parking spot; and
(g) reporting said central unit, by using reporting means, the parking starting time of said occasional vehicle in said selected parking spot, or alternatively, reporting said central unit whenever said parking spot is occupied by a vehicle related to the owner of said parking spot.

20. The method according to claim 19, wherein the one or more parameters are selected from the group consisting of: a destination address, the current location of the vehicle or the mobile device, departure time, vehicle identification information, parameters related to the surrounding or infrastructure of a parking spot, or any combination thereof.

21. The method according to claim 20, wherein the other information is provided by the central unit, and which said other information is selected from the group consisting of: the distance of the available parking spot(s) from the vehicle or the mobile device, the distance of the available parking spot(s) from the destination address, parking rate(s) of each available parking spot, parking spot's address or other guiding information, departure time or any other restricting information regarding the parking of a vehicle in said parking spot(s), a unique identification code for each parking spot, or any combination thereof.

22. The method according to claim 19, further comprising charging the owner of the occasional vehicle or the owner of the mobile device according to the parking period of said occasional vehicle in the available parking spot using a billing module related to the central unit.

23. The method according to claim 19, further comprising comparing the current location of the mobile device and the coordinates of the selected parking spot, and whenever said current location and said coordinates are within the same predetermined range, passively operating the reporting means.

24. The method according to claim 19, wherein the reporting means are located within the parking area or the parking spot, wherein said reporting means are selected from the group consisting of: a remote control, keypad, touch screen, mechanical operated mechanism (e.g., operated by key, by lever, by handle, etc.), biometric reader, optical module for identifying the parking vehicle or its license plate, RFID reader, or any combination thereof.

25. The method according to claim 19, wherein the provided information allows to send an alert message in case of a theft attempt or an alert message that include an updated digital photo of the parked vehicle.

26. The method according to claim 19, further comprising providing commercial content to the mobile device based on the current location of the vehicle's driver or based on the location of the selected parking area.
